(19) United States
(12) Patent Application Publication
(10) Pub. No.: US 2026/0278884 A1
(43) Pub. Date: Sep. 17, 2026

(54) Goal-Directed Development Life Cycle

(71) Applicant: Umajin Inc., Boston, MA (US)

(72) Inventor: David Brebner, Palmerston North (NZ)

(21) Appl. No.: 19/568,475

(22) Filed: Mar. 16, 2026

Related U.S. Application Data
(60) Provisional application No. 63/772,251, filed on Mar. 14, 2025.

(51) Int. Cl. G06T 11/60; G06F 40/40

(52) U.S. Cl. CPC G06T 11/60; G06F 40/40

(57) ABSTRACT

An improved application system is provided, the application system being of the type including a simulation engine and a virtualized software environment, the simulation engine running on top of the virtualized software environment and enabling creation and editing of a directed acyclic graph, known as a tree, the tree having nested and typed nodes and viewed by a user. The improvement includes a conversational editing system configured to map a set of natural language instructions, received from the user, into a corresponding set of manipulations of the tree that are validated against a schema, and a viewer that presents to the user a visual representation of the tree as modified by the set of manipulations for approval or refinement.

### RELATED APPLICATION

This application claims the benefit of U.S. Provisional Application No. 63/772,251, filed Mar. 14, 2025, entitled “Goal-Directed Conversational Development,” which is hereby incorporated herein by reference in its entirety.

### SUMMARY OF THE EMBODIMENTS

In accordance with one embodiment of the invention, there is provided a nontransitory storage medium encoded with instructions, for use with a plurality of computer systems, each one of which is in communication in real time over a network with other computer systems of the plurality of computer systems. The instructions, when executed on each of the computer systems, establish, on each computer system, an application system, wherein the application system includes a simulation engine and a virtualized software environment. The simulation engine runs on top of the virtualized software environment and enables creation and editing of a project by a plurality of network users and viewing of the project by a local user. In this context, the simulation engine includes:
a conversational editing system (“CE system”) configured to map a text-based input from a user, in a form selected from the group consisting of speech and a string of textual characters, into a corresponding set of manipulations of the declared scene tree;
a validation processor for validating the corresponding set of manipulations against a schema;
a scene tree object manager that (a) manages objects, their relationships, properties, and behaviors in the declared scene tree of objects, (b) causes transformation of the declared scene tree of objects so as to be mirrored in an instantiated scene tree of objects, and (c) causes changing of the instantiated scene tree based on an update to the project made by any of the plurality of network users;
a viewer that presents to the local user a visual representation of the instantiated scene tree in its current state;
an editor listener, coupled to the network, that receives and processes any change message, from any of the other computer systems, by causing the declaration processor to transform a change declaration embedded in such received change message into a corresponding change in the instantiated scene tree, wherein the change declaration includes an update to the project by one of the plurality of network users; and
a rendering processor, coupled to the virtualized software environment, to requisition hardware resources to cause physical manifestation of the instantiated scene tree, the physical manifestation being optimized by evaluation of hardware resources for allocation in order to achieve the physical manifestation.

In a further related embodiment, the simulation engine further includes a visual editor configured to show what is being changed by the CE system specifically in the scene tree and visually in a WYSIWYG view; a persistence processor in communication with the scene tree object manager, that causes mirroring, of the instantiated scene tree of objects, in a second declaration; and an editor broadcaster, coupled to the network, that obtains changes from the visual editor and causes the persistence processor to transform a correspondingly changed part of the instantiated scene tree into a change declaration and broadcasts the change declaration embedded in a change message over the network to the other computer systems.

In a further related embodiment, the visual editor is further configured wherein with respect to each transactional change in the scene tree, the user is presented with an opportunity (1) to approve this transaction, (2) to refine this transaction with more feedback, or (3) to roll back this transaction.

In another embodiment, there is provided an improved application system of the type including a simulation engine and a virtualized software environment, the simulation engine running on top of the virtualized software environment and enabling creation and editing of a directed acyclic graph, known as a tree, and the tree having nested and typed nodes and viewed by a user. In this embodiment, the improvement includes:
a conversational editing system configured to map a text-based input from a user, in a form selected from the group consisting of speech and a string of textual characters, into a corresponding set of manipulations of the tree;
a validation processor for validating the corresponding set of manipulations against a schema; and
a viewer that presents to the user a visual representation of the tree as modified by the set of manipulations for approval or refinement.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing features of embodiments will be more readily understood by reference to the following detailed description, taken with reference to the accompanying drawings, in which:

FIGS. 1A, 1B, and 1C illustrate three stages in use and operation of a conversational editing interface in accordance with an embodiment of the present invention. In FIG. 1A is illustrated the use of text or speech to produce a declaration. In turn, as shown in FIG. 1B, the declaration has been processed to produce a scene tree, namely, a representation of objects, and their relationships, properties, and behaviors. In FIG. 1C, the scene tree of FIG. 1B is shown in the course of being modified.

FIGS. 2A and 2B provide an example of how a text conversation can be used to edit a scene tree in the CE system. In FIG. 2A is shown an original scene tree that a user can seek to modify by providing a textual command. The results of the command provided to the situation of FIG. 2A are shown in FIG. 2B.

FIG. 3 is a block diagram showing logical processes carried out to create and execute a computer program in a computer environment in accordance with an embodiment of the present invention.

FIG. 4 illustrates exemplary steps for user invocation of a CE system in accordance with an embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

A “set” has at least one member.

A “computer process” is the performance of a described function in a computer using computer hardware (such as a processor, field-programmable gate array or other electronic combinatorial logic, or similar device), which may be operating under control of software or firmware or a combination of any of these or operating outside control of any of the foregoing. All or part of the described function may be performed by active or passive electronic components, such as transistors or resistors. In using the term “computer process” we do not necessarily require a schedulable entity, or operation of a computer program or a part thereof, although, in some embodiments, a computer process may be implemented by such a schedulable entity, or operation of a computer program or a part thereof. Furthermore, unless the context otherwise requires, a “process” may be implemented using more than one processor or more than one (single-or multi-processor) computer.

An “operating system” is an environment of a host computer system, which may be a conventional operating system, but alternatively may be any computing environment that can cause execution of computer instructions, receive input and provide output, including, for example, a web browser, a Java runtime environment, a Microsoft common language runtime environment, etc.

A “cloud infrastructure” is an environment supporting input and output over a network and by which there is caused execution of computer instructions over the network.

A “virtualized” software environment is an environment by providing a layer of abstraction on top of a specific operating system or a specific cloud infrastructure, so that interaction with the virtualized software environment is independent of the specific operating system or the specific cloud infrastructure

An “application system” is a system selected from the group consisting of (i) a virtualized software system that is configurable to exist on top of any desired operating system and (ii) a virtualized cloud infrastructure that is configured to exist on top of any desired cloud infrastructure and (iii) combinations thereof.

A “simulation engine” is a software functionality that runs on top the “application system.”

A “frame clock” is a timing mechanism defining successive frames with respect to which operations of the simulation engine are synchronized.

A first computer system is in communication “in real time” over a network with a second computer system, when information is exchanged bidirectionally between the computer systems according to scheduling determined by the first and second computer systems and without dependency on polling.

A “declared scene tree” is a hierarchical map of objects and their relationships, properties, and behaviors, defined by a declaration, and that are capable of being instantiated.

When a declared scene tree is instantiated so as to produce an “instantiated scene tree” (also sometimes called a “scene graph”), the result is an abstract computing device, by which the instantiated scene tree is rendered, if at all, only in accordance with the virtualized software environment of the given computer device. Accordingly, when the given computing device is a replication computer, there is no rendering of the instantiated scene tree at all.

A “visible scene tree” is a representation of objects, and their relationships, properties, and behaviors, in a corresponding scene tree, that are simultaneously visible in a display.

An “interactive scene tree” is a representation of objects, and their relationships, properties, and behaviors, in a corresponding scene tree, that are simultaneously available for user interaction in a display.

A “temporal assignment” is the specifying, effective at an initial time, of (i) a set of target values for a corresponding set of variables, (ii) a target time at which the target set of values is to be achieved, and (iii) and a time-varying function by which the target set of values is to be achieved. The time-varying function is operative over successive frame counts to transform the initial set of values at the initial time to the target set of values at the target time, using the ratio of the (a) amount of time remaining to reach the target time to (b) to the difference between the target time and the initial time.

An “temporal procedure” is the specifying, effective immediately, of (i) a procedure and a set of parameters for the procedure, (ii) a target time at which the procedure will be invoked, and (iii) optionally, a number of times over which the procedure will be repeated.

A computer process defined by a temporal assignment or by a temporal procedure is subject to a “software contract” when configured by the assignment to carry out the process under conditions selected from the group consisting of best efforts, guaranteed, and combinations thereof.

A “best efforts” software contract associated with a computer process is when the process is carried out on a frame-by-frame basis, wherein, if tasks defined for a given frame cannot be carried out, then processing moves to tasks associated with the next frame even if the defined tasks have not been carried out.

A “guaranteed” software contract associated with a computer process is when the process is carried out on an absolute basis wherein tasks associated with a target frame must be carried out before proceeding to tasks associated with a succeeding frame.

“Linear logic” is a set of procedures that can be executed strictly from left to right, or top to bottom, without looping or branching, and that can be defined with zero, one, or more parameters.

An “declaration repository” of a repository server system in a multi-user network is a shared storage facility in which is stored a log of each change made in any declaration by any user on the network to any scene tree accessible over the network and which communicates with an off-line synchronizer of each client to provide, to such client, any changes on the stored log that had not been synchronized when such client had been offline.

“AI alignment” aims to steer AI systems toward a person's or group's intended goals, preferences, or ethical principles.

“AI Validation” is a rigorous assessment and verification of data, models, and algorithms to ensure consistency and precision in their performance.

“AI Schema Validation” includes checking that data items fit a predefined data model or structure. This structure specifies the data types, format, and inter-relationships of the fields in the data.

A “Vision language model (VLM)” is a multimodal, generative AI model capable of understanding and processing video, image, and text.

A “Global unique identifier” (GUID) is used to name objects uniquely in a multi-user environment.

A “Conversational editing system” (hereinafter, a “CE system”) includes an ability to provide a voice or chat interface to allow users to edit all aspects of a scene tree in a multi-user session in a safe and auditable transactional manner without needing to use a traditional graphical user interface (“GUI”), which typically requires use of a mouse or touch screen in conjunction with a keyboard.

According to an “Editing context,” a CE system can use the context of the current scene tree, the current root node or nodes (current page or pages) or the current selected node or nodes (object selection or multi-selection).

A “Tree Transaction” is a packaged set of changes (additions, updates or deletions) to the nodes, properties or actions of the scene tree that can be applied or rolled back in a manner that is similar to processes employed in source code management systems.

“Discovery” is a mechanism to display to the user the schema for tree nodes/objects

Embodiments of the present invention provide improvements over the subject matter described in the inventor's U.S. Pat. No. 10,846,816 (my “Prior Application Engine Patent”), entitled Multi-User Application System Environment Engine, issued Nov. 24, 2020, which is hereby incorporated herein by reference in its entirety. My Prior Application Engine Patent describes subject matter that is also shared and implemented in embodiments of the present invention. The shared subject matter, as I wrote at the time, provides
an environment in which computer processes are made subservient to a human-oriented set of requirements and goals. The requirements and goals are specified at a high level by the user in a manner independent of the hardware, operating system and software libraries, and it is then up to the computer software to work out how to meet these requirements and goals. In embodiments of the present invention, the requirements and goals are specified by the user in a new layer, which we call an “application system,” wherein the interaction is accomplished using [a] simulation engine. The simulation engine can exploit many pre-compiled highly efficient subsystems with lazy evaluation, domain specific heuristics and machine learning to achieve the goals extremely efficiently. Importantly, unlike normal software, which requires just in time or static compilation before it is run, the application system provides, in its user interface, what we call “declarations,” which can be updated live while they are being simulated. [Col. 1, lines 31-49]

In this subject matter, disclosed in my Prior Application Engine Patent and also used in embodiments of the present invention, the simulation engine is operated in a manner that is machine independent, a result that is achieved by providing the “application system” described in the passage quoted immediately above. The “simulation engine” and the “application system” are defined in my Prior Application Engine Patent in this manner:
An “application system” is a system selected from the group consisting of (i) a virtualized software system that is configurable to exist on top of any desired operating system and (ii) a virtualized cloud infrastructure that is configured to exist on top of any desired cloud infrastructure and (iii) combinations thereof. A “simulation engine” is a software functionality, in the portion of the application system that runs on top the [operating system]. [col 6, lines 48-55]
   Although this technology typically requires different versions of the application system in order to operate with different operating systems running on a computer system of interest, the simulation engine can potentially be the same for each computer system context, since the simulation engine need interface only with the application system and not with the operating system.

This arrangement is further explained my Prior Application Engine Patent this way:
. . . a multi-user application system environment engine has an application system that, in turn, includes a simulation engine and a virtualized software environment. The simulation engine runs on top of the virtualized software environment and includes a declaration processor, a scene tree object manager, a persistence processor in communication with the scene tree object manager, a visual editor, an editor broadcaster, an editor listener, and a rendering processor, coupled to the virtualized software environment, to requisition hardware resources to cause physical manifestation of an instantiated scene tree of objects. [col. 1, lines 50-61]

All of the components (with one exception) in the passage immediately above—namely, the declaration processor, the scene tree object manager, the persistence processor in communication with the scene tree object manager, a visual editor, an editor broadcaster, an editor listener, and the rendering processor, as well as the virtualized software environment—appear in various embodiments of the present invention. (The “declaration processor” mentioned above is not needed in various embodiments of the present invention, for reasons that we address below in the next paragraph.)

The one significant difference between embodiments of the present invention and embodiments of the technology disclosed in my Prior Application Engine Patent is that all embodiments of the present invention include a conversational editing system (“CE system”). The availability of the CE system in embodiments of the present invention removes the requirement of the declaration processor. As explained in further detail below, the CE system allows a textual input from the user to effectuate changes to the scene tree with corresponding changes to the declaration, and vice versa.

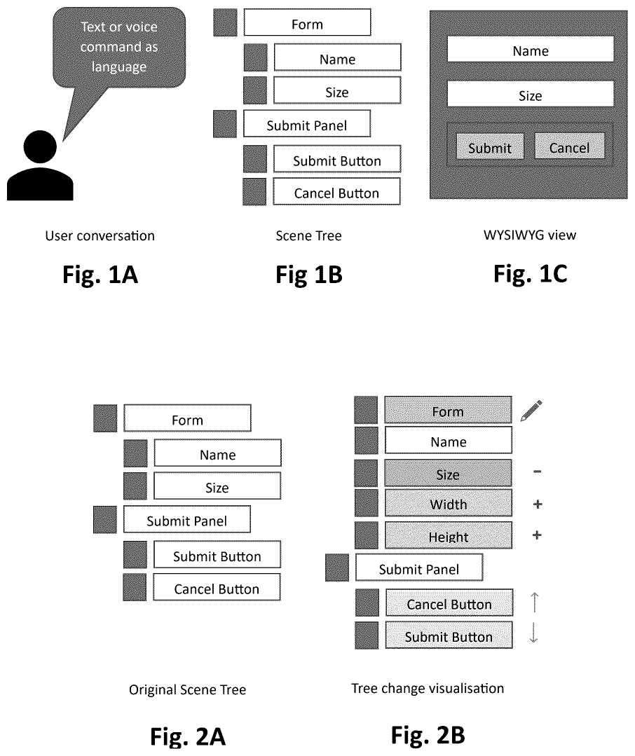

FIGS. 1A, 1B, and 1C illustrate three stages in use and operation of a conversational editing interface in accordance with an embodiment of the present invention. In FIG. 1A is illustrated the use of text or speech to produce a declaration. In turn, as shown in FIG. 1B, the declaration has been processed to produce a scene tree, namely. a representation of objects, and their relationships, properties, and behaviors, In FIG. 1C, the scene tree of FIG. 1B is shown in the course of being modified.

One advantageous feature of a conversational editing system (CE system), according to embodiments of the present invention, is that it can leverage some form of vision language model (VLM) that enables users to map their written or spoken instructions to manipulate a tree of nested and typed nodes, with each node having a list of properties represented as name-value pairs. The vision language model provides an underlying representation of many important data structures including data files, documents and publications. The visual representation established by the vision language model can range, from a simple rendering in print of the textual values of the nodes as an indented tree, to a unique WYSIWYG visual rendering for each node based on the node's type and its properties.

To make the CE system useful for goal-directed development, we propose extending the CE system to accommodate nodes that may also include a list of possible named events, wherein each of these events in turn has a list of actions that take a list of parameters as name-value pairs. Accordingly, in this embodiment of the CE system, the nodes and properties thus define static goals and the events and actions define dynamic goals.

The specific challenge for the CE system is that the nodes, the node types, the properties, the events, the possible actions and their parameters at runtime all need to be formally defined so that they can be invoked by the user in selecting plugins or by enumerating external cloud systems. The CE system goes beyond merely accepting textual input from the user by also providing a unique visual representation of the rendering of a type of node. In such an environment, the VLM needs to be able to map these formal definitions of the tree and visual representation in a manner that is responsive to the user's informal language. In various embodiments, the VLM accommodates external actions such as those enumerated by external web services via standards like OpenAPI or the Model Context Protocol (MCP). (https://swagger.io/specification/ & https://modelcontextprotocol.io/introduction).

In various embodiments, the CE system is structured in accordance with a suitable textual schema (including descriptions) and corresponding counterparts that are implemented in an instantiated scene tree, so that the CE system can supply context to the VLM to map to the user's request.

Users are likely to draw on visual descriptions, analogies to existing information as well as to use synonyms, colloquialisms and idioms. The user may also supply editing context by highlighting a specific scene tree, or a page of the scene tree or a selection of object or objects. These user requests need to be processed by the CE system as a conversation to produce one or more formal transaction proposals applying to the editing context. These proposed transactions will contain a textual description along with the proposed additions, updates and deletion of nodes and their properties and actions inside the transaction option. Updates can also include moving the nodes order within the tree or changing a nodes parent.

Each of these potential transactions needs to be examined in the course of an internal validation phase using the CE system and the visual large language model, before being presented to the user, to ensure that the recommended manipulation of the tree is aligned with the user's request visually, interactively, and to ensure that the transaction is validated to be formatted to match the dynamic enumerated definitions of node types, properties, events, actions and parameters.

Multiple WYSIWYG previews may be rendered for the VLM including edit and runtime previews. Providing a set of previews is important because the instantiated version of the scene tree at run time will include additional dynamic objects and potentially have nodes presenting data. Additional text artifacts are created to supply meta data including bounding boxes, so the VLM can line up the spatial location of the node with its text properties using a Global unique identifier (GUID).

Multiple options are presented wherein multiple validated options have high alignment scores. Under such circumstances, the user is provided an opportunity to make more than one choice. The user can also choose not to select an option, or, alternatively, to refine one of the choices with further queries or clarifications.

Validating transactions in relation to the formal schema of the CE system enables the CE system to participate safely with other users in a multi-user editing session of manipulating the tree (or Umajin Abstract Scene Tree). The CE system allows changes made by a user to the scene tree to be visualized in the WYSIWYG view of the rendering so the user can pick a transaction option (if more than one has high alignment). When an option is previewed, the visual editor will show what is being changed specifically in the tree and visually in the WYSIWYG view. With respect to each transactional change in the scene tree, the user can then (1) approve this transaction, (2) refine this transaction with more feedback or (3) roll back this transaction.

A benefit of the conversational interface is that it makes editing the scene tree possible without needing a GUI interface, then the visual editor can simulate and render the scene tree in a “What You See Is What You Get” (WYSIWYG) manner so the user can see the resulting application.

In addition, unlike the user experience afforded by a conventional GUI, the conversational interface very easily allows for editing many nodes at once and to have macro-like capabilities as the conversational input can refer to whole classes of objects in the tree to be operated on based on the textual input acting as a filter and with the benefit of additional context/constraints applied based on selected pages and objects. Another benefit of the CE system is that it continues the conversation and keeps the context of the changes being made to the scene tree. Because all transactions that are applied are stored, this memory can also persist between editing sessions.

Maintaining the structure of the tree, which is a directed acyclic graph with a defined schema as to types of nodes, properties, events and assigned actions, is critical for any formal data structure. Such an approach allows the underlying application system to be able to visualize correctly the goal-directed scene tree at edit time and simulate it at run time.

To manage multiple users and CE systems participating in manipulating this scene tree in real time during a Visual Editor session, each node is an object in the scene tree and is associated with a unique identifier, which we call a GUID. This is a required property of all nodes/objects so as to ensure management of conflicting changes from different users and CE systems during the multi-user editing process.

FIGS. 2A and 2B provide an example of how a text conversation can be used to edit a scene tree in the CE system. In this example the textual input can generate a transaction that is similar to a source code management changeset. As illustrated below, in the course of the editing process, the CE system provides a WYSIWYG view of the change caused by the end, and the CE system can also provide a visualization of the proposed changes by using different colors and icons to indicate the proposed changes.

In FIG. 2A is shown an original scene tree that a user can seek to modify by providing a textual command. The user may command the CE system thus: “Change the width property of the form to make it larger and remove the size field but add in fields for width and height. Then swap around the submit and cancel buttons.” The results of thecommand provided to the situation of FIG. 2A are shown in FIG. 2B, wherein the edits cause the following: 1. Changing a property of the Form object to alter its width. (The change is highlighted with a pencil icon and a color change to blue) 2. Deleting the Size object (The change is highlighted with a minus icon and a color change to red). 3. Adding in two new objects called “Width” and “Height” (The change is highlighted with a plus icon and a color change to green) 4. Moving positions of the Cancel and Submit objects by exchanging their locations (The changes in position are highlighted with arrow icons and a color change to yellow).

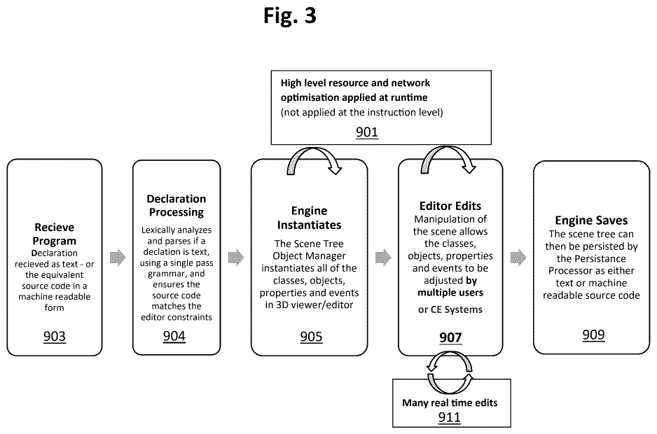

FIG. 3 is a block diagram showing logical processes carried out to create and execute a computer program in a computer environment in accordance with an embodiment of the present invention. FIG. 3 illustrates functions of a CE system in accordance with an embodiment of the present invention, the functions being modified compared with those of existing systems to allow the CE system to propose new edits that can be approved by the users, for example, during a multi-user editing session. The CE system of the present invention differs from a conventional system in that edits by a user can apply to many objects, properties and actions at the same time by being implemented as a tree transaction applied to the scene tree.

Further referring to FIG. 3, stage 901 illustrates that high-level resource and network optimization may be applied at runtime (in comparison to being applied at the instruction level). At the Receive Program stage 903, a declaration is received as text, or the equivalent source code in a machine-readable form. At the Declaration Processing stage 904, the declaration is lexically analyzed, and, if the declaration is provided as text, the declaration is parsed; a single pass grammar is used, and it is ensured that the source code matches the editor constraints.

At the Engine Instantiates stage 905, the Scene Tree Object Manager instantiates all of the classes, objects, properties and events in a 3D viewer/editor. At the Editor Edits stage 907, the CE system supports adjustment of the classes, objects, properties and events by multiple users or CE Systems. At the Engine Saves stage 909, the Persistence Processor causes persisting of the scene tree as either text or machine-readable source code. At stage 911, there may be many real time edits. Each edit is a transaction, acting on the scene tree, and may be reversed. The editing steps are a cyclical process that continues until the desired resulting tree is achieved.

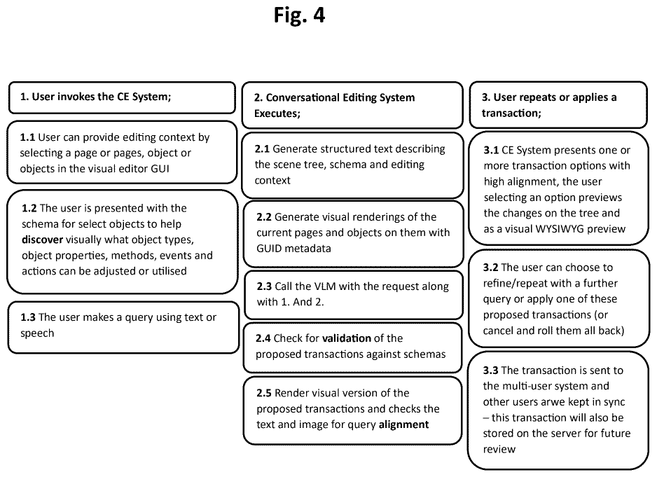

FIG. 4 illustrates exemplary steps for user invocation of a CE system in accordance with an embodiment of the present invention. Specifically, per item 1.1, a user can provide editing context by selecting a page or pages, object or objects in the visual editor GUI. Per item 1.2, the user is presented with the schema for selected objects to help the user discover visually what object types, object properties, methods, events and actions can be adjusted or utilized. Per item 1.3, the user makes a query using text or speech.

Per item 2.1, there is generated structured text describing the scene tree, schema and, editing context. Per item 2.2, there are generated visual renderings of the current pages and objects on them with GUID metadata. Per item 2.3, the Vision Language Model or other system capable of evaluating an image alongside textual instructions is invoked with the user's request. Per item 2.4, there is a check for validation of the proposed transactions against schemas. Per item 2.5, a visual version of the proposed transactions is rendered, and the text and image are checked for query alignment.

Per item 3.1, the CE system presents one or more transaction options with high alignment, and the user selecting an option previews the changes on the tree and as a visual WYSIWYG preview. Per item 3.2, the user can choose to refine or repeat with a further query or apply one of these proposed transactions (or cancel and roll them all back). Per item 3.3, the transaction is sent to the multi-user system, and other users are kept in sync. This transaction is also stored on the server for future review.

3D and AR. Importantly the CE system in accordance with an embodiment of the present invention may be implemented with a set of displays providing information in three dimensions, wherein the implied camera angle and position can be manipulated to provide important information as the objects which are close and visible are the context. This embodiment is exceptionally powerful in the context of augmented reality with a digital twin. For example, the CE system can support walking by a user around a facility and looking at the equipment in the real world while the user is also presented with digital twin information that is overlaid on the real world experience. In such a context, a developer can alter the digital twin 3D application layer. Similarly an end user can be provided a context for usage of the application and for calling methods and requesting data to be analyzed or compared. At runtime the Vision Language Model or other system capable of evaluating an image alongside a textual instructions schema can be extended to inspecting runtime properties of the digital twin or triggering events on objects using text or voice commands.

The Vision Language Model or other system capable of evaluating an image alongside textual instruction can use both the visual representation generated by the 3D engine projected from potentially multiple viewpoints as well as the formal scene tree representation.

There is a broad range of potential types of interactions by a user with the scene tree simulated by the application system in accordance with an embodiment of the present invention. For example, the user may interact using a desktop computer, or by providing a textual input via a mobile phone using speech or by providing typed text as the textual imput. In all cases, the visual representation is modified as dictated by the particular textual input that has been provided by the user.

Because the instantiated scene does not need to be stored, the multi-user mode and formal selection of the tree edit by the user are not necessarily required. Consequently, the CE system can be provided as an end user interface. This would be ideal where the end user customer would like to make changes to designs, 3D environments, digital twins or dashboards and reports, which are common application-level tasks.

The Vision Language Model or other system capable of evaluating an image alongside textual instruction can also provide an additional context window or approaches like Retrieval Augmented Generation or other authoritative sources like vector databases, so the language the user uses is tuned for the vertical domain of the application. As examples, the CE system may be configured to enable surgeons to use medical terms and processes as the context for the digital twin of a patient, and automotive engineers may be provided with a context of the vehicle, materials, processes and product variants.

The scene tree is capable of representing applications that extend beyond desktop, smartphone, VR and AR applications. The objects, properties and events in this decomposable graph can describe digital twins, along with the digital twin sub systems and sub system behaviors. As a result, custom rendering systems for different types of scene trees allow visual images of these scene trees to be created. With these images the graph can be edited with conversational visual editing despite very different application domains, as the image can be examined with a Vision Language Model or other system capable of evaluating an image alongside the textual instruction and text of the persisted scene tree.

The scene tree changes created during the conversational editing session as described above are presented to the user for user validation. In the case of more complex applications of digital twins or even procedural code generators, this “change set” forms an important context by which the user can understand the goals specified by the updated scene tree. The change set can be transformed into a set of proposed steps which need to be taken to achieve the goals set out by the graph. These may involve updating or building other digital artifacts such as images, procedural code, audio, video, 3D models, sample data, mathematical formulae, information searches, and validating queries. This list of tasks along with the subgraph forms a precisely defined context window, and the goals provide a mathematically complete non-Turing representation for validation of human or digital agents acting in concert to achieve the required tasks. The planning, context, and validation allow for tasks to be successfully delegated, undertaken, completed and verified in a logical hierarchy with the smallest possible scope. This reduces the risk that a human or digital agent will make an error or misinterpret the requirements needed to create artifacts achieving the goals of the changes to the graph.

The task list can include sub tasks, such as a new form requiring a design specialty or a new part for a vehicle requiring an engineering specialty. Debugging and documentation would be other logical types of roles that give a human or digital agent further context for the work outlined in the tasks and sub tasks.

This also means that any tasks and resulting artifacts created or updated are part of the changeset resulting from the conversational editing of the scene tree. This is critical for complex systems as it provides a clear chain of generation and makes system auditing and validation possible.

Importantly because the artifacts generated have extremely clear goals, specifications and context-the system could change the generation process and the resulting artefact can still be validated. This means that a process for generating images, the computer language used for procedural code generation or the approach for building 3D models can be altered and still deliver the discrete goal directed development outcomes. Because a scene tree is a directed acyclic graph, it is by definition decomposable into equally valid sub graphs.

This means that in applications and digital twins there can be nodes representing a sub graph that might be a repeated part, such as in the case of an engine on a plane. These sub graphs are still connected to the overall scene tree so can benefit from all of the capabilities like adding variations where just some objects, properties and events may vary based on a given state. During a conversational editing session therefore the engine may need to act on each engine sub graph within a scene tree in the case of a digital twin of a multiple engine plane.

The subject matter of the present invention extends beyond form-based applications and even fancier 3D applications discussed herein to describing a broad class of digital twins—things like organic molecules, vehicles, buildings, anything which is constructed of many parts each with sub parts, properties and behaviours—in that the custom renderer allows these to be used during CE as the VLM can now see what a user's changes to the graph are doing visually to the rendering of the digital twin (from multiple angles). ty, civil engineering, radiologist etc

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

While the invention has been particularly shown and described with reference to specific embodiments, it will be understood by those skilled in the art that various changes in form and detail may be made therein without departing from the spirit and scope of the invention as defined by the appended clauses. While some of these embodiments have been described in the claims by process steps, an apparatus comprising a computer with associated display capable of executing the process steps in the clams below is also included in the present invention. Likewise, a computer program product including computer executable instructions for executing the process steps in the claims below and stored on a computer readable medium is included within the present invention.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A nontransitory storage medium encoded with instructions, for use with a plurality of computer systems, each one of which is in communication in real time over a network with other computer systems of the plurality of computer systems, wherein the instructions, when executed on each of the computer systems, establish, on each computer system, an application system, wherein the application system includes a simulation engine and a virtualized software environment, the simulation engine running on top of the virtualized software environment and enabling creation and editing of a project by a plurality of network users and viewing of the project by a local user, wherein the simulation engine comprises:
a conversational editing system (“CE system”) configured to map a text-based input from a user, in a form selected from the group consisting of speech and a string of textual characters, into a corresponding set of manipulations of the declared scene tree;
a validation processor for validating the corresponding set of manipulations against a schema;
a scene tree object manager that (a) manages objects, their relationships, properties, and behaviors in the declared scene tree of objects, (b) causes transformation of the declared scene tree of objects so as to be mirrored in an instantiated scene tree of objects, and (c) causes changing of the instantiated scene tree based on an update to the project made by any of the plurality of network users;
a viewer that presents to the local user a visual representation of the instantiated scene tree in its current state;
an editor listener, coupled to the network, that receives and processes any change message, from any of the other computer systems, by causing the declaration processor to transform a change declaration embedded in such received change message into a corresponding change in the instantiated scene tree, wherein the change declaration includes an update to the project by one of the plurality of network users; and
a rendering processor, coupled to the virtualized software environment, to requisition hardware resources to cause physical manifestation of the instantiated scene tree, the physical manifestation being optimized by evaluation of hardware resources for allocation in order to achieve the physical manifestation.

2. A nontransitory storage medium according to claim 1, wherein the simulation engine further comprises:
a visual editor configured to show what is being changed by the CE system specifically in the scene tree and visually in a WYSIWYG view;
a persistence processor in communication with the scene tree object manager, that causes mirroring, of the instantiated scene tree of objects, in a second declaration; and
an editor broadcaster, coupled to the network, that obtains changes from the visual editor and causes the persistence processor to transform a correspondingly changed part of the instantiated scene tree into a change declaration and broadcasts the change declaration embedded in a change message over the network to the other computer systems.

3. A nontransitory storage medium according to claim 2, wherein the visual editor is further configured wherein with respect to each transactional change in the scene tree, the user is presented with an opportunity (1) to approve this transaction, (2) to refine this transaction with more feedback, or (3) to roll back this transaction.

4. An improved application system of the type including a simulation engine and a virtualized software environment, the simulation engine running on top of the virtualized software environment and enabling creation and editing of a directed acyclic graph, known as a tree, the tree having nested and typed nodes and viewed by a user, wherein the improvement comprises:
a conversational editing system configured to map a text-based input from a user, in a form selected from the group consisting of speech and a string of textual characters, into a corresponding set of manipulations of the tree;
a validation processor for validating the corresponding set of manipulations against a schema, and
a viewer that presents to the user a visual representation of the tree as modified by the set of manipulations for approval or refinement.
